(19) United States
(12) Patent Application Publication
(10) Pub. No.: US 2026/0209577 A1
(43) Pub. Date: Jul. 23, 2026

(54) MOISTURE-PERMEABLE HOT MELT PROCESSABLE MEDICAL ADHESIVES

(71) Applicant: Solventum Intellectual Properties Company, Maplewood, MN (US)

(72) Inventors: Ying Zhang, Woodbury, MN (US); Adam R. Wohl, Mahtomedi, MN (US); Man Han, Woodbury, MN (US); Barbara L. Kellen, Baldwin, WI (US)

(73) Assignee: Solventum Intellectual Properties Company, Maplewood, MN (US)

(21) Appl. No.: 19/138,759

(22) PCT Filed: Dec. 14, 2023
(86) PCT No.: PCT/IB2023/062691

§ 371 Date: Jun. 13, 2025

Related U.S. Application Data
(60) Provisional application No. 63/434,115, filed on Dec. 21, 2022.

(51) Int. Cl. C09J 133/10; C09J 7/38

(52) U.S. Cl. CPC C09J 133/10; C09J 7/385; C09J 2301/208; C09J 2301/302; C09J 2301/416; C09J 2433/00

(57) ABSTRACT

Articles include a substrate, and a layer disposed on the substrate, the layer being at least one hot melt processable pressure sensitive adhesive that has been coated and photocrosslinked. The adhesive is a (meth)acrylate-based copolymer that is the reaction product of a reaction mixture of a first (meth)acrylate monomer containing an alkyl, alkenyl, or aryl group with 4-20 carbon atoms, a second (meth)acrylate monomer containing an alkylene oxide group that is capped with an alkyl group, a co-polymerizable reinforcing monomer, a co-polymerizable photocrosslinker, and an initiator.

### SUMMARY

Disclosed herein are adhesive compositions that are hot melt processable pressure sensitive adhesives that are phototcrosslinkable. In particular, articles that contain the adhesive compositions are disclosed.

In some embodiments, the articles comprise a substrate, and a layer disposed on at least a portion of the substrate, the layer comprising at least one hot melt processable pressure sensitive adhesive that has been coated and photocrosslinked. The at least one hot melt processable pressure sensitive adhesive comprises a (meth)acrylate-based copolymer that is the reaction product of a reaction mixture comprising at least one first (meth)acrylate monomer of general formula I:

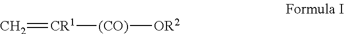

where R¹ is hydrogen or a methyl group; and R² is an alkyl, alkenyl, or aryl group comprising 4-20 carbon atoms; and at least one second (meth)acrylate monomer of general Formula II:

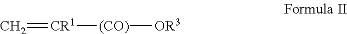

where R¹ is hydrogen or a methyl group; and R³ is an alkylene oxide group that is capped with an alkyl group; at least one co-polymerizable reinforcing monomer; at least one co-polymerizable photocrosslinker; and at least one initiator.

### DETAILED DESCRIPTION

The use of adhesive products in the medical industry has long been prevalent and is increasing. However, while adhesives and adhesive articles have shown themselves to be very useful for medical applications, there are also issues in the use of adhesives and adhesive articles. In particular, the desired properties for adhesives are often contradictory. For example, it is desirable that the adhesives have high adhesion to an array of surfaces, including human skin, and yet the adhesive also is desirably removable without damaging the skin. Additionally, medical articles are being worn for longer periods of time, needing to remain adhered and yet need to be removable without damaging the skin or leaving residue.

Another need in medical adhesives is to make the adhesives more hydrophilic to aid the moisture vapor transmission rate (MVTR) properties for long term wear. A wide variety of medical articles and devices are intended to remain adhered to the skin for extended periods of time. Current adhesive systems have difficulty remaining on the skin for extended periods of time because they suffer from moisture loading, that is to say, from moisture trapped between the skin and the adhesive layer because the adhesive has inadequate MVTR which results in “float off” of the system. MVTR is a measure of the passage of water vapor through a substance or barrier. Because perspiration naturally occurs on the skin, if the MVTR of a material or adhesive system is low, this can result in moisture accumulation between the skin and the adhesive that can cause the adhesive to “float off” or peel away and also can promote other detrimental effects such as bacterial growth and skin irritation. Therefore, much work has focused upon the development of adhesive systems that have a high MVTR. Typically, the adhesive is designed to be hydrophilic, so that moisture from the skin will pass through the adhesive layer and not accumulate at the skin/adhesive interface. Since the adhesives are typically hydrocarbon-rich and therefore non-polar and hydrophobic, one method used to make the adhesives more hydrophilic is to add hydrophilic plasticizers. Typically, these plasticizers are poly-alkylene oxide-based plasticizers. A drawback of this approach is that since the plasticizers are free materials, they can migrate to surface of the adhesive composition and be left behind as residue when the adhesive is removed.

Another trend in the adhesive art is to prepare adhesives without using solvents. There are a variety of environmental and other reasons for eliminating solvent in the preparation of adhesive articles, but manufacturing adhesives, such as (meth)acrylate-based adhesives, without using solvents can be difficult. Among the methods developed to prepare and coat adhesive systems are 100% solids systems, such as hot melt processable pressure sensitive adhesives. Difficulties have arisen when solvent processing has been replaced by hot melt processing. Often it is difficult to replicate the properties of solvent delivered adhesive layers with hot melt delivered systems.

Thus, among the desirable, and often contradictory, features desired for a medical adhesive include: high enough adhesion to attach to skin without causing skin damage or leaving residue upon removal; have sufficiently high cohesive strength to be useful; have high MVTR for long term wearability; and be hot melt processable so that the use of solvents is not required.

Disclosed herein are adhesive compositions and articles containing the adhesive compositions, where the adhesives are (meth)acrylate-based and contain monomers that have alkyl-capped polyalkyene oxide groups. These groups aid in providing high MVTR but, because they are part of the polymeric matrix are not free to migrate to the surface and be transferred as residue, as is the case with added plasticizers. The adhesives are desirable wet stick adhesives in that they adhere to both wet and dry skin.

The term “adhesive” as used herein refers to polymeric compositions useful to adhere together two adherends. Examples of adhesives are pressure sensitive adhesives.

Pressure sensitive adhesive compositions are well known to those of ordinary skill in the art to possess properties including the following: (1) aggressive and permanent tack, (2) adherence with no more than finger pressure, (3) sufficient ability to hold onto an adherend, and (4) sufficient cohesive strength to be cleanly removable from the adherend. Materials that have been found to function well as pressure sensitive adhesives are polymers designed and formulated to exhibit the requisite viscoelastic properties resulting in a desired balance of tack, peel adhesion, and shear holding power. Obtaining the proper balance of properties is not a simple process.

As used herein, the term “wet-stick adhesive” refers to a material that exhibits pressure sensitive adhesive properties when adhered to at least a wet surface, generally, to both wet and dry surfaces, particularly skin.

The term “(meth)acrylate” refers to monomeric acrylic or methacrylic esters of alcohols. Acrylate and methacrylate monomers or oligomers are referred to collectively herein as “(meth)acrylates”. Materials referred to as “(meth)acrylate-based” are materials that contain a majority of one or more (meth)acrylates, and may also contain co-polymerizable monomers.

The terms “room temperature” and “ambient temperature” are used interchangeably to mean temperatures in the range of 20° C. to 25° C.

The terms “Tg” and “glass transition temperature” are used interchangeably. If measured, Tg values are determined by Differential Scanning Calorimetry (DSC) at a scan rate of 10° C./minute, unless otherwise indicated. Typically, Tg values for copolymers are not measured but are calculated using the well-known Fox Equation, using the monomer Tg values provided by the monomer supplier, as is understood by one of skill in the art.

The term “adjacent” as used herein when referring to two layers means that the two layers are in proximity with one another with no intervening open space between them. They may be in direct contact with one another (e.g. laminated together) or there may be intervening layers.

The terms “polymer” and “macromolecule” are used herein consistent with their common usage in chemistry. Polymers and macromolecules are composed of many repeated subunits. As used herein, the term “macromolecule” is used to describe a group attached to a monomer that has multiple repeating units. The term “polymer” is used to describe the resultant material formed from a polymerization reaction.

The term “PROTEIN LEATHER” is used herein, according to its commonly understood meaning. Protein leather, also known as Pleather, is composed of protein powder along with resin to form pliable sheets. These sheets are a look-alike to leather in appearance as well as durability.

The term “alkyl” refers to a monovalent group that is a radical of an alkane, which is a saturated hydrocarbon. The alkyl can be linear, branched, cyclic, or combinations thereof and typically has 1 to 20 carbon atoms. In some embodiments, the alkyl group contains 1 to 18, 1 to 12, 1 to 10, 1 to 8, 1 to 6, or 1 to 4 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, and ethylhexyl.

The term “alkenyl” refers to a monovalent group that is a radical of an alkene, which is an unsaturated hydrocarbon. The alkenyl can be linear, branched, cyclic, or combinations thereof and typically has 3 to 20 carbon atoms. In some embodiments, the alkenyl group contains 3 to 18, 3 to 12, 3 to 10, 3 to 8, 3 to 6, or 3 to 4 carbon atoms

The term “aryl” refers to a monovalent group that is aromatic and carbocyclic. The aryl can have one to five rings that are connected to or fused to the aromatic ring. The other ring structures can be aromatic, non-aromatic, or combinations thereof. Examples of aryl groups include, but are not limited to, phenyl, biphenyl, terphenyl, anthryl, naphthyl, acenaphthyl, anthraquinonyl, phenanthryl, anthracenyl, pyrenyl, perylenyl, and fluorenyl.

The term “alkylene” refers to a divalent group that is a radical of an alkane. The alkylene can be straight-chained, branched, cyclic, or combinations thereof. The alkylene often has 1 to 20 carbon atoms. In some embodiments, the alkylene contains 1 to 18, 1 to 12, 1 to 10, 1 to 8, 1 to 6, or 1 to 4 carbon atoms. The radical centers of the alkylene can be on the same carbon atom (i.e., an alkylidene) or on different carbon atoms.

The term “heteroalkylene” refers to a divalent group that includes at least two alkylene groups connected by a thio, oxy, or —NR— where R is alkyl. The heteroalkylene can be linear, branched, cyclic, substituted with alkyl groups, or combinations thereof. Some heteroalkylenes are polyoxyalkylenes where the heteroatom is oxygen such as for example, —(CH₂CH₂O)ₙCH₂CH₂O—. The terms “polyoxyalkylenes” and “polyalkylene oxide” are used interchangeably. As used herein, the term “alkylene oxide group that is capped with an alkyl group” refers to a monovalent group that contains an end-capped polyoxyalkylene group of the type —(CH₂CH₂O)ₙCH₂CH₂OR, where R is an alkyl group.

The terms “free radically polymerizable” and “ethylenically unsaturated” are used interchangeably and refer to a reactive group which contains a carbon-carbon double bond which is able to be polymerized via a free radical polymerization mechanism.

Disclosed herein are articles, particularly medical articles, that comprise a substrate and a layer on at least a portion of the substrate, where the layer comprises at least one hot melt processable pressure sensitive adhesive that has been coated and photocrosslinked. The at least one hot melt processable pressure sensitive adhesive comprises a (meth)acrylate-based copolymer that is the reaction product of a reaction mixture. The reaction mixture comprises polymerizable components, at least one initiator, and optional non-polymerizable components. The polymerizable components include at least one first (meth)acrylate monomer of general formula I:

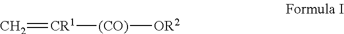

where R¹ is hydrogen or a methyl group; and R² is an alkyl, alkenyl, or aryl group comprising 4-20 carbon atoms; at least one second (meth)acrylate monomer of general Formula II:

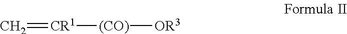

where R¹ is hydrogen or a methyl group, and R³ is an alkylene oxide group that is capped with an alkyl group, at least one co-polymerizable reinforcing monomer, and at least one co-polymerizable photocrosslinker. Each of the reactive components, initiators and optional components are described in greater detail below.

The adhesive compositions are hot melt processable. The term “hot melt processable” is not a process description or limitation, but rather is a material description, meaning that the adhesive compositions are capable of being hot melt processed, and not that the compositions necessarily have been hot melt processed or need to be hot melt processed.

The articles of this disclosure comprise a substrate. A wide variety of substrates are suitable for the articles of this disclosure. In many embodiments, the substrate comprises a substrate suitable for use in a medical article. These articles may or may not be breathable, that is to say, transmissive of moisture. Examples of suitable substrates include a medical substrate or a release liner. Exemplary medical substrates include polymeric materials, plastics, natural macromolecular materials (e.g., collagen, wood, cork, silk, and leather), paper, cloth, fabrics, non-wovens, composites, and combinations thereof. The medical substrate may be a tape backing. Examples of suitable tape backings include breathable conformable backing, on which the adhesive is disposed. A wide range of breathable conformable backings are suitable for use in articles of this disclosure. Typically, the breathable conformable backing comprises a woven or knit textile, a nonwoven, or a plastic.

In some embodiments, the breathable conformable backing comprises a high moisture vapor permeable film backing. Examples of such backings, methods of making such films, and methods for testing their permeability are described, for example, in U.S. Pat. Nos. 3,645,835 and 4,595,001. Typically, such backings are porous materials.

Generally, the backing is conformable to anatomical surfaces. As such, when the backing is applied to an anatomical surface, it conforms to the surface even when the surface is moved. Generally, the backing is also conformable to animal anatomical joints. When the joint is flexed and then returned to its unflexed position, the backing stretches to accommodate the flexion of the joint but is resilient enough to continue to conform to the joint when the joint is returned to its unflexed condition.

Examples of particularly suitable backings can be found in U.S. Pat. Nos. 5,088,483 and 5,160,315, and include elastomeric polyurethane, polyester, or polyether block amide films. These films have a combination of desirable properties including resiliency, high moisture vapor permeability, and transparency.

In some embodiments, the substrate may be a release liner. Release liners are sheet materials that have a low adhesion coating on at least one surface. The hot melt processable pressure sensitive adhesives of the present disclosure can be disposed on a release liner to generate an article comprising a layer of pressure sensitive adhesive on a release liner. This adhesive/release liner article can be used to prepare other adhesive/substrate articles by laminating the adhesive layer to different substrate and then removing the release liner. This permits the adhesive to be disposed onto substrates to which it is difficult to directly dispose the hot melt processable pressure sensitive adhesive, such as substrates that are thermally sensitive. The adhesive/release liner article may also be used to apply the pressure sensitive adhesive layer to an article such as, for example, an electrode, an ostomy device, or the like. The devices may not be breathable.

Also disclosed herein are hot melt processable pressure sensitive adhesive compositions. The compositions are disposed on the substrate to form an adhesive layer that is then photocrosslinked to form a photocrosslinked pressure sensitive adhesive layer. Therefore, the articles also comprise a layer of at least one hot melt processable pressure sensitive adhesive that has been coated and photocrosslinked. By at least one it is meant that the layer may comprise a single hot melt processable pressure sensitive adhesive composition or it may contain more than one hot melt processable pressure sensitive adhesive composition, where the different compositions may be blended or be present in separate sublayers within the layer.

The hot melt processable pressure sensitive adhesive composition comprises a (meth)acrylate-based copolymer that is the reaction product of a reaction mixture. The reaction mixture comprises polymerizable components, at least one initiator, and optional non-polymerizable components. The polymerizable components include at least one first (meth)acrylate monomer, at least one second (meth)acrylate monomer, at least one co-polymerizable reinforcing monomer, at least one co-polymerizable photocrosslinker, and at least one initiator. The reaction mixture may also comprise optional components. Each of the reactive components, initiators and optional components are described in greater detail below.

As mentioned above, the reaction mixture comprises at least one first (meth)acrylate monomer of general Formula I:

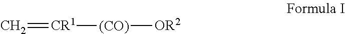

where R¹ is hydrogen or a methyl group; and R² is an alkyl, alkenyl, or aryl group comprising 4-20 carbon atoms. In some embodiments, R² is an alkyl, group comprising 4-12 carbon atoms. In many embodiments, the first (meth)acrylate monomer comprises a mixture of (meth)acrylate monomers. Examples of suitable first (meth)acrylate monomers include BA (butyl acrylate), PA (propyl acrylate), HA (hexyl acrylate), 2-EHA (2-ethyl hexyl acrylate), IOA (iso-octyl acrylate), heptyl acrylate, octyl acrylate, nonyl acrylate, decyl acrylate, and dodecyl acrylate. Examples of particularly suitable first (meth)acrylate monomers include BA (butyl acrylate), 2-EHA (2-ethyl hexyl acrylate), IOA (iso-octyl acrylate), and LA (lauryl acrylate).

The reaction mixture also comprises at least one second (meth)acrylate monomer is of general Formula II:

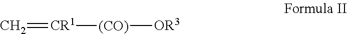

where R¹ is hydrogen or a methyl group, and R³ is an alkylene oxide group that is capped with an alkyl group. In some embodiments, R³ is a polyethylene oxide group capped with an alkyl group. In some particularly suitable embodiments, R³ is of general Formula III:

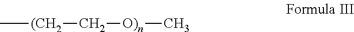

where n is an integer of 8-230. Examples of suitable second (meth)acrylate monomers include an acrylate formed from CARBOWAX 750 a methoxypolyethylene glycol of 750 molecular weight and MPEG500 a methoxypolyethylene glycol acrylate of 550 molecular weight.

The reaction mixture also comprises at least one reinforcing monomer. The co-polymerizable reinforcing monomer is a monoethylenically unsaturated monomer that increases the glass transition temperature and cohesive strength of the copolymer. Mixtures of reinforcing monomers may also be used. Generally, the reinforcing monomer has a homopolymer Tg of at least about 10° C. Typically, the reinforcing monomer is a reinforcing (meth)acrylic monomer, including an acrylic acid, a methacrylic acid, an acrylamide, or a (meth)acrylate. Examples include, but are not limited to, acrylamides, such as acrylamide, methacrylamide, N-methyl acrylamide, N-ethyl acrylamide, N-hydroxyethyl acrylamide, diacetone acrylamide, N,N-dimethyl acrylamide, N, N-diethyl acrylamide, N-ethyl-N-aminoethyl acrylamide, N-ethyl-N-hydroxyethyl acrylamide, N,N-dihydroxyethyl acrylamide, t-butyl acrylamide, N,N-dimethylaminoethyl acrylamide, and N-octyl acrylamide. Other examples of reinforcing monomers include itaconic acid, crotonic acid, maleic acid, fumaric acid, 2,2-(diethoxy)ethyl acrylate, 2-hydroxyethyl acrylate or methacrylate, 3-hydroxypropyl acrylate or methacrylate, methyl methacrylate, isobornyl acrylate, 2-(phenoxy)ethyl acrylate or methacrylate, biphenylyl acrylate, t-butylphenyl acrylate, cyclohexyl acrylate, dimethyladamantyl acrylate, 2-naphthyl acrylate, phenyl acrylate, N-vinyl formamide, N-vinyl acetamide, N-vinyl pyrrolidone, and N-vinyl caprolactam. Particularly suitable reinforcing monomers are acid-functional monomers. Acrylic acid, because it is readily available, is particularly useful.

The reaction mixture also comprises at least one co-polymerizable photocrosslinker. Co-polymerizable photocrosslinkers are materials that contain a free radically polymerizable group to co-polymerize with the monomers described above. The co-polymerizable photocrosslinkers also contain a photosensitive group that upon exposure to the right wavelength of light, typically high intensity ultra-violet (UV) radiation, the photosensitive group forms free radicals which can form crosslinks in the polymer. If the (meth)acrylate-based polymer is formed using a photoinitiator, the photocrosslinker is not activated by the same wavelengths of light as the photoinitiator. In this way, the co-polymerizable photocrosslinker is incorporated into the polymer, and is able to be thermally processed, as the crosslinker is thermally stable and remains intact until activated by the proper wavelength of light. This prevents the co-polymerizable photocrosslinker from becoming activated until the polymer has been hot melt coated. In some embodiments, these crosslinkers are activated by UV light generated from artificial sources such as medium pressure mercury lamps or a UV blacklight.

Suitable photocrosslinkers in the mono-ethylenically unsaturated aromatic ketone co-monomers that are free of ortho-aromatic hydroxyl groups such as those described in U.S. Pat. No. 4,737,559 (Kellen et al.). Specific examples include para-acryloxybenzophenone (ABP), para-acrylyoxyethoxybenzophenone (AEBP), ketalated acryloxyethoxybenzophenone (KAEBP) as described in U.S. Pat. No. 10,189,771 (Benson et al.), para-N-(methylacryloxyethyl)-carbamoylethoxybenzophenone, para-acryloxyacetophenone, ortho-acrylamidoacetophenone, acrylated anthraquinones, and the like. Particularly suitable is ABP para-acryloxybenzophenone also called 4-acryloxybenzophenone, AEBP (para-acrylyoxyethoxybenzophenone), and KAEBP (ketalated acryloxyethoxybenzophenone).

The reactive mixture also comprises at least one initiator. Typically, the initiator is a photoinitiator, meaning that the initiator is activated by light, typically ultraviolet (UV) light. As mentioned above, suitable photoinitiators are those that are activated by light that is different from the light that activates the photocrosslinking. Photoinitiators are well understood by one of skill in the art of (meth)acrylate polymerization. Examples of suitable free radical photoinitiators include DAROCURE 1173, DAROCURE 4265, IRGACURE 184, IRGACURE 651, IRGACURE 1173, IRGACURE 819, LUCIRIN TPO, LUCIRIN TPO-L, commercially available from BASF, Charlotte, NC. The photoinitiator IRGACURE 1173 is particularly suitable.

The relative amounts of the components of the reaction mixture may vary as desired. In some embodiments, the reaction mixture comprises:
50-85 parts by weight of at least one first monomer;
10-30 parts by weight of at least one second monomer;
3-25 parts by weight of at least one co-polymerizable reinforcing monomer;
0.05-0.5 parts by weight of at least one co-polymerizable photocrosslinker; and
0.01-1.0 parts by weight of initiator.

The term “parts by weight” is used to describe the quantity by weight of the reactive material present in the mixture. This term is similar to but is not to be confused with “weight %” or “% by weight”. Typically, the components add up to total 100 parts by weight and thus parts by weight is the same as weight %, but in many embodiments the reactive components do not add up precisely to 100 parts by weight. In these embodiments, the term parts by weight are close to but not exactly the same as weight %. For example, a reactive mixture that includes 70 parts by weight of first monomer, 20 parts by weight of second monomer, 10 parts by weight of co-polymerizable reinforcing monomer, and 0.1 parts by weight of co-polymerizable photocrosslinker, has approximately 70 weight % first monomer, but since the parts by weight of the monomers adds up to greater than 100, it is not correct to use that terminology.

The reaction mixture used to prepare the at least one hot melt processable pressure sensitive adhesive may contain additional optional additives. The additives may be reactive or non-reactive with the reactive components described above. Among the reactive additives are chemical crosslinkers, also known as covalent crosslinkers and chain transfer agents. Among the non-reactive additives are anti-oxidants and plasticizers.

The crosslinking agent, if used, is used in an effective amount, by which is meant an amount that is sufficient to cause crosslinking without interfering with the hot melt processability of the polymerized adhesive composition. Generally, the crosslinking agent, if used, is used in an amount of less than 0.01 parts by weight.

One class of useful crosslinking agents are multifunctional (meth)acrylate species. Multifunctional (meth)acrylates include tri(meth)acrylates and di(meth)acrylates (that is, compounds comprising three or two (meth)acrylate groups). Typically, di(meth)acrylate crosslinkers (that is, compounds comprising two (meth)acrylate groups) are used. Useful di(meth)acrylates include, for example, ethylene glycol di(meth)acrylate, diethylene glycol di(meth)acrylate, triethylene glycol di(meth)acrylate, tetraethylene glycol di(meth)acrylate, 1,4-butanediol di(meth)acrylate, 1,6-hexanediol di(meth)acrylate, alkoxylated 1,6-hexanediol diacrylates, tripropylene glycol diacrylate, dipropylene glycol diacrylate, cyclohexane dimethanol di(meth)acrylate, alkoxylated cyclohexane dimethanol diacrylates, ethoxylated bisphenol A di(meth)acrylates, neopentyl glycol diacrylate, polyethylene glycol di(meth)acrylates, polypropylene glycol di(meth)acrylates, and urethane di(meth)acrylates. The di(meth)acrylate HDDA (1,6-hexanediol diacrylate) is particularly suitable.

One particularly suitable optional additive is a chain transfer agent. Examples of useful chain transfer agents include, but are not limited to, those selected from the group consisting of carbon tetrabromide, mercaptans, alcohols, and mixtures thereof. A particularly suitable chain transfer agent is IOTG (isooctyl thioglycolate). Chain transfer agents and the use of chain transfer agents is well understood in the adhesive arts. If used, chain transfer agents are typically present in an amount of up to 0.30 parts by weight.

As mentioned above, the reaction mixture may contain non-reactive components that play a useful function in the adhesive layer when formed, but do not participate in the polymerization reaction that forms the adhesive composition. Suitable additives are those that do not interfere with the polymerization reaction. Examples include plasticizers and anti-oxidants, with anti-oxidants being particularly suitable. Commercially available anti-oxidants include the IRGANOX series from BASF, such as IRGANOX 1076 and IRGANOX 1010. Typically, if used, anti-oxidants are present in an amount of up to 0.5 parts by weight.

The hot melt processable adhesive composition is formed by polymerizing the reaction mixture containing the components described above. The initiator is activated, typically by light, to initiate the polymerization. The polymerization may be carried out in a solvent or as a 100% solids mixture. Typically, 100% solids polymerization is more desirable. In some embodiments, the reactive components are mixed in the absence of a solvent and polymerized to form the hot melt processable pressure sensitive adhesive composition.

In many embodiments of this disclosure, the polymerization is carried out within a sealed package as described in U.S. Pat. No. 5,804,610 (Hamer et al.). In this method, the reaction mixture components described above are sealed in a package comprising a thermoplastic material. These packages are then polymerized to form the hot melt processable pressure sensitive adhesive composition within the package.

In this method, two lengths of thermoplastic film are heat sealed together across the bottom and on each of the lateral edges on a liquid form-fill-seal machine to form an open-ended pouch. Particularly suitable thermoplastic film materials are polyethylene and EVA (ethylene vinyl acetate). The reactive mixture is pumped through a hose to fill the pouch, and the pouch is then heat sealed across the top to completely surround the adhesive composition.

Typically, the reactive mixture is polymerized by activation of the photoinitiator by radiation of the appropriate wavelength, typically UV radiation. In many embodiments, the packaged pre-adhesive composition is immersed in a heat exchange medium to moderate the generation of excessive heat during the polymerization. In many embodiments, the heat exchange medium is water maintained at room temperature.

Upon completion of the polymerization, a packaged adhesive composition is generated. This packaged adhesive composition can be used immediately, stored for later use, or shipped to a different location for hot melt processing.

The adhesive layer of the articles of this disclosure are formed by disposing at least one of the hot melt processable pressure sensitive adhesive compositions described above onto the surface of the substrate to form an adhesive layer and then photocrosslinking the adhesive layer by exposure of the adhesive layer to actinic radiation.

The adhesive composition can be applied to the surface by any conventional application method, including, but not limited to, extrusion coating, gravure coating, curtain coating, slot coating, spin coating, screen coating, transfer coating, brush or roller coating, and the like. The adhesive composition can be applied to the microstructured surface as a hot melt composition, a solvent-borne composition or a 100% solids composition. The adhesive coating can be further processed to produce the adhesive layer. The processing can include drying of the adhesive layer coating if solvent-borne or cooling of the adhesive layer coating if hot melt coated.

In many embodiments, the hot melt processable pressure sensitive adhesive composition may be disposed onto the surface of the substrate by hot melt coating. Hot melt coating is particularly suitable for when the adhesive compositions are prepared as 100% solids compositions. This dispenses with the need to dry the coated adhesive compositions and eliminates the need for the use of solvents. Optional components such as anti-oxidants, plasticizers or tackifiers can be added to the hot melt processable pressure sensitive adhesive composition. These optional additives can be added in addition to or instead of adding additives to the reactive mixture.

A variety of hot melt mixing techniques using a variety of hot melt mixing equipment are suitable for processing the hot melt processable pressure sensitive adhesive compositions. Both batch and continuous mixing equipment may be used. Examples of batch methods include those using a BRABENDER (e. g. a BRABENDER PREP CENTER, commercially available from C.W. Brabender Instruments, Inc.; South Hackensack, NJ) or BANBURY internal mixing and roll milling equipment (e.g. equipment available from Farrel Co.; Ansonia, CN). Examples of continuous methods include single screw extruding, twin screw extruding, disk extruding, reciprocating single screw extruding, and pin barrel single screw extruding. Continuous methods can utilize distributive elements, pin mixing elements, static mixing elements, and dispersive elements such as MADDOCK mixing elements and SAXTON mixing elements. A single hot melt mixing apparatus may be used, or a combination of hot melt mixing equipment may be used to process the packaged adhesive compositions of this disclosure.

The output of the hot melt mixing is coated onto the substrate to form an adhesive layer. If a batch apparatus is used, the resulting hot melt blend can be removed from the apparatus and placed in a hot melt coater or extruder and coated onto a substrate. If an extruder is used to prepare a hot melt blend, the blend can be directly extruded onto a substrate to form an adhesive layer in a continuous forming method. In the continuous forming method, the adhesive can be drawn out of a film die and subsequently contacted to the substrate surface.

In many embodiments of this disclosure, the hot melt processable pressure sensitive adhesive composition comprises a hot melt processable packaged adhesive composition. Methods for preparing hot melt processable packaged adhesive compositions are described above. The hot melt processable packaged adhesive compositions are formed by surrounding the reaction mixture components described above in a package comprising a thermoplastic material and polymerizing the reactive components within the package. The package can then be added to an extruder, additional optional components can be added if desired, and the adhesive composition hot melt coated onto the surface of the substrate.

The adhesive layer thus formed may be a continuous layer, a patterned layer, or a combination thereof. Additionally, the adhesive layer may comprise sublayers. The sublayers may be the same adhesive material, or they may be different adhesive materials. If the sublayers are different materials, typically the different materials are hot melt processable pressure sensitive adhesive compositions of the type described above. The sublayers may likewise be continuous layers or patterned layers. In some embodiments, the adhesive layer comprises two sublayers, a first sublayer comprising a continuous layer, and a second sublayer disposed on the first sublayer in a pattern.

After the hot melt processable pressure sensitive adhesive layer is disposed on the substrate surface, the hot melt processable pressure sensitive adhesive layer is photocrosslinked, by subjecting the adhesive layer to a photocrosslinking process. In this process, the photosensitive crosslinker is activated by exposure to high intensity UV lamps to effect crosslinking. Examples of suitable UV lamps include medium pressure mercury lamps.

The thickness of the photocrosslinked adhesive layer, can vary depending upon a number of factors such as the desired use of the adhesive article, whether the adhesive layer contains sublayers, and the like. Typically, the thickness of the adhesive layer may be in the range from about 0.05 to about 200 micrometers.

As mentioned above, the adhesive articles of this disclosure have a variety of desirable properties. Many of these properties make the adhesive articles particularly suitable in medical applications. As mentioned above, one particularly desirable feature is a high moisture vapor transmission (MVT). This property can be measured in a variety of ways. The method of MCT measurement used in this disclosure and described in the Examples section, uses articles that comprise a polyurethane film substrate with an adhesive layer. Such articles have a 24-hour inverted Moisture Vapor Transmission (MVT) rate of 350-20,000 g/m².

Also, among the desirable properties of the articles of this disclosure are adhesion to both wet and dry surfaces. This property renders the adhesive articles suitable for use on wet or dry skin. The adhesion of adhesive articles to wet or dry skin can be modeled in a variety of ways. In this disclosure, PROTEIN LEATHER is used as a particularly suitable test surface. PROTEIN LEATHER refers to artificial leather (sometimes called pleather) that is composed of protein powder along with resin to form pliable sheets. These sheets are a look-alike to leather in appearance as well as durability. The use of PROTEIN LEATHER in testing of samples is explained in detail in the Examples section. One particularly suitable PROTEIN LEATHER is PROTEIN LEATHER PBZ13001 KAKI form IDEATEX Japan Co.

In some embodiments, the adhesive articles have adhesion to dry PROTEIN LEATHER of 40-400 grams/inch. In some embodiments, the adhesive article has adhesion to wet PROTEIN LEATHER of 30-300 grams/inch.

### EXAMPLES

These examples are merely for illustrative purposes only and are not meant to be limiting on the scope of the appended claims. All parts, percentages, ratios, etc. in the examples and the rest of the specification are by weight, unless noted otherwise. Solvents and other reagents used were obtained from Sigma-Aldrich Chemical Company; Milwaukee, Wisconsin unless otherwise noted. The following abbreviations are used: m=meters; cm=centimeters; mm=millimeters; nm=nanometers; in=inch; RPM=revolutions per minute; oz=ounces; g=grams; kg=kilograms; lb=pounds; mL=milliliters; dL=deciliters; Pa=Pascals; h=hours; mW=milliWatts; mJ=milliJoules; kGy=kiloGray; PPM=parts per million.

TABLE of
Abbreviations

| | |
|---|---|
| 2EHA | 2-Ethylhexyl acrylate, obtained from BASF, Corporation, Florham Park, |
| | NJ |
| AA | Acrylic acid, available from BASF Corporation, Florham Park, NJ. |
| BA | Butyl acrylate, available from BASF Corporation, Florham Park, NJ. |
| IOA | Isooctyl acrylate, made in-house at 3M by standard procedures |
| GA-1 | Glycol Acrylate-1, methoxypolyethylene glycol acrylate 750, prepared |
| | from CARBOWAX 750 from Dow chemicals |
| GA-2 | Glycol Acrylate-2, Methoxypolyethyleneglycol acrylate, molecular |
| | weight ~550, prepared from MPEG500, Osaka |
| DDA | A mixture of 2-dodecyl acrylate, 3-dodecyl acrylate, 4-dodecyl acrylate, |
| | 5-dodecyl acrylate, and 6-dodecyl acrylate prepared as in Example 9 of |
| | U.S. Pat. No. 9,102,774 (Clapper et al.) |
| PI | a photo initiator composed of 2-Hydroxy-2-methyl-1-phenyl-propan-1- |
| | one, commercially available as “IRGACURE 1173” from BASF, |
| | Ludwigshafen, Germany |
| PI-2 | Photo initiator commercially available as “OMNIRAD 1173” from IGM |
| | Resins |
| IOTG | Iso-octyl thioglycolate, chain transfer agent, Evans Chemetics LP |
| HDDA | 1,6-Hexanediol acrylate, obtained under the trade designation |
| | “LAROMER HDDA” from BASF Corp |
| ABP | 4-Acryloxy benzophenone made in-house at 3M by standard procedures |
| KAEBP | Ketalated acryloxyethoxybenzophenone, prepared generally as described |
| | in Example 1 of U.S. Pat. No. 10,189,771 (Benson et al.) |
| NVP | N-vinyl pyrrolidone |
| AO-1 | Octadecyl-3-[3,5-di-tert-butyl-4-hydroxyphenyl]propionate, an |
| | antioxidant available under the trade designation “IRGANOX 1076” |
| | from BASF, Ludwigshafen, Germany |
| AO-2 | Tetrakis(methylene(3,5-di-tert-butyl-4-hydroxyhydrocinnamate))methane, an antioxidant |
| | available under the trade designation “IRGANOX 1010” from BASF Corporation, Vandalia, |
| | Illinois |
| Ethyl Acetate | Ethyl acetate, obtained from Honeywell, Charlotte, NC |
| THF | Tetrahydrofuran stabilized with 250 ppm BHT, obtained from |
| | MilliporeSigma Co., Burlington, MA |
| EVA film | A clear poly(ethylene vinyl acetate) film, 0.065 mm thick, which was |
| | produced using a blown film process from an EVA copolymer resin |
| | obtained under the trade designation “ELEVATE EF546AA” from |
| | Westlake Chemical Corporation, Houston, TX |
| Release Liner | Filmbyna TSB/TSC, Double side silicone coated 50 μm PET film, |
| | FUJIMORI KOGYO |
| Sontara | Sontara 8010, PET spunlace, Nissei |
| EO/PO BC | Ethylene oxide/propylene oxide block copolymer commercially available |
| | as “PLURONIC 25R4” from BASF, Ludwigshafen, Germany |

### Preparation of “100% Solids” or “Bulk” Polymers Used in the Examples

Monomer mixtures were prepared by blending reactive acrylic monomers, photo initiator and antioxidant, in a jar. To this mixture was added a magnetic stir bar, and the mixture was placed on a stir plate, forming a curable composition. EVA film was heat sealed to form open ended receptacles each measuring 18 cm by 5 cm. Each receptacle was filled with approximately 24 grams of the curable composition. Air was forced out of the open end which was then sealed using a heat sealer (obtained under the trade designation “MIDWEST PACIFIC IMPULSE SEALER” from J.J. Elemer Corp., St. Louis, MO). A sealed EVA film receptacle having the curable composition enclosed within the was immersed in a constant temperature water bath at 16° C. and irradiated with ultraviolet light (365 nm, 4.5 mW/cm²) for nine minutes on each side to polymerize the curable composition.

### Test Methods

### Test Method 1A: Determination of Gel Content

A rectangular polymer sample of approximately 24 g was placed onto the center of a pre-weighed rectangular mesh. The mesh was a square weave wire cloth, stainless steel type 304, of woven construction, 150 mesh, using 0.0026 inch (66 micrometer) wire, and 0.0041 inch (104 micrometer) openings (obtained under the trade designation “MCMASTER-CARR”, from McMaster-Carr Co., Elmhurst, IL). The overhanging portion of the mesh was folded inwards to cover and immobilize the sample inside the mesh. The folded mesh with the enclosed polymer was weighed and then immersed in approximately 8 oz. (approx. 240 mL) of ethyl acetate inside a glass jar that was placed on a mechanical roller for 24 hours. The mesh with the polymer was then taken out of the jar and dried in an oven for 30 minutes at 120° C. and weighed again to calculate the sample mass. The gelled insoluble portion of the polymer was calculated as a gel weight percent (“gel wt. %”) using the following equation:

$$Gel Wt . \% = \frac{( final weight of undissolved polymer + mesh ) - ( weight of mesh )}{( initial weight of polymer + mesh ) - ( weight of mesh )} \times 100$$

### Test Method 1B: Determination of Gel Content

A sample was compounded in a Bonnot. The heated sample was pumped to a twin screw extruder. The resulting hotmelt was coated onto a silicone release liner using a rod coater die. The extrusion temperatures for the die and extruder were kept at 320° F. (160° C.). The extruded sample was coated at 1.5 mil (38 micrometers) thickness. The samples were then immediately cured at 40-50 mJ/cm² of UV-C, using a UV fusion lamp and H-bulb. A polymer sample of approximately 1-2 g was placed onto the center of a pre-weighed rectangular mesh. The mesh was a square weave wire cloth, stainless steel type 304, of woven construction, 150 mesh, using 0.0026 inch (66 micrometer) wire, and 0.0041 inch (104 micrometer) openings (obtained under the trade designation “MCMASTER-CARR”, from McMaster-Carr Co., Elmhurst, IL). The overhanging portion of the mesh was folded inwards to cover and immobilize the sample inside the mesh. The folded mesh with the enclosed polymer was weighed and then immersed in approximately 2 oz. of ethyl acetate inside a glass jar that was placed on a mechanical roller for 4 hours. The ethyl acetate containing dissolved polymer was removed, 2 oz. of fresh ethyl acetate was added to the jar, and the sample was rolled on a mechanical roller overnight. The mesh with the polymer was then taken out of the jar and dried in an oven for 16 hours at 65° C. and weighed again to calculate the sample mass. The gelled insoluble portion of the polymer was calculated as a gel weight percent (“gel wt. %”) using the following equation:

$$Gel Wt . \% = \frac{( final weight of undissolved polymer + mesh ) - ( weight of mesh )}{( initial weight of polymer + mesh ) - ( weight of mesh )} \times 100$$

### Determination of Inherent Viscosity (“IV”)

The inherent viscosities (“IVs”) reported herein were obtained by conventional methods known to those of ordinary skill in the art. The IVs were obtained using a single-bath dilute solution polymer viscometer (obtained under the trade designation “MINIPV-X” from Cannon Instrument Co., State College, PA) in a water bath controlled at 27° C., to measure the flow time of 10 mL of a polymer solution (0.25 g/dL polymer in ethyl acetate). The test procedure that was followed and the apparatus used are described in detail in Textbook of Polymer Science, F. W. Billmeyer, Wiley-Interscience, Second Edition, 1971, Pages 84 and 85.

### Adhesion to Steel Testing

Adhesion to steel test specimens, measuring 1.27 centimeters by 12.7 centimeters, were cut. Next, the liner was removed from the adhesive to place the adhesive on a test panel using two passes of a 2.0-kilogram steel roller in each direction. Test surface was #320 stainless steel. The peel test was carried out using a Zwick tensile tester (Z005) equipped with a 50 kg load cell at room temperature with a separation rate of 30.5 centimeters/minute. The average peel force was recorded and used to calculate the average peel adhesion strength in gram/centimeter. The test was done in replicate of six. The reported results are an average of 3 measurements as oz/inch or oz/25 mm and converted to Newtons/decimeter (N/dm).

### Shear Testing

Shear test specimens, measuring 1 inch by 3 inches (2.54×7.62 cm), were cut. A 1 inch (2.54 cm) sample was left hanging off the edge of the panel and was folded over center of the adapter hood, making sure the end was folded back squarely and the doubled portion was at least 1 inch (2.54 cm) long. The area between the panel and the hook was reinforced with orange tape and stapled. The plate was transferred to the shear stand, a 500-gram weight was hung on the hook, and the time until the weight fell was recorded.

### MVTR Testing

Moisture Vapor Transmission Rate (MVTR) testing was completed using a method based on European Standard EN 13726-2-2002. Samples were pre-cut with a diameter of 55.6 mm. A foil ring with a 42 mm inter-diameter and 62 mm outer-diameter was placed over the dressing sample.

To test upright MVTR, 20 mL of deionized water was placed inside the cup, then the pre-cut 55.6 mm diameter sample with foil ring was placed over the opening in the cup with the adhesive facing downward. The top plate was then placed on top of the sample and the screws were tightened. The cup was weighed and the mass of the cup, sample and liquid was recorded as W₁. The cup was placed in the chamber at a temperature of 37° C.±1° C. and 19% relative humidity with the sample facing upward and not in contact with the liquid. After 18-24 hours, the cup was removed from the chamber and the cup, sample and liquid were immediately reweighed and the mass recorded as W₂. The time the cup was in the chamber was recorded as T₁. The upright MVTR was calculated using formula below:

$$X = ( {W}_{1} - {W}_{2} ) \times 1000 \times 24 / {T}_{1}$$

### Where:

X is Upright MVTR (g m⁻² 24 h⁻¹)
W₁ is the mass of the cup, sample and liquid before test period
W₂ is the mass of the cup, sample and liquid after test period
T₁ is the test period in hours.

For the inverted MVTR measurement, a new set of dressings and cups were used. Thirty ml of deionized water was used for the inverted MVTR testing. The cup was inverted and placed in the chamber with the sample facing downward and in contact with the liquid. After 4 hours, the cup was removed from the chamber and the cup, sample and liquid were immediately reweighed and the mass was recorded as W₃. The time the cup was in the chamber was recorded as T₂. The inverted MVTR was calculated using formula below:

$$X = ( {W}_{1} - {W}_{3} ) \times 1000 \times 24 / {T}_{2}$$

### Where:

X is Inverted MVTR (g m⁻² 24 h⁻¹)
W₁ is the mass of the cup, sample and liquid before the test period with the test solution in contact with dressing (i.e., before inverting the cylinder)
W₃ is the mass of the cup, sample and liquid after test period with the test solution in contact with the dressing.
T₂ is the test period in hours.

If the inverted MVTR of the test sample was less than 1000 g m⁻² 24 h⁻¹ after 4 hours, the samples were placed back into the chamber for a total time of 18-24 hours and the results were recalculated.

### Rheology Testing

Rheological testing was conducted with a transfer adhesive using an ARES G2 Rheometer equipped with an 8 mm parallel plate fixture (top) and 25 mm parallel plate fixture (bottom). A small amplitude oscillatory shear was performed at 10 rad/s while simultaneously ramping the temperature from 25° C. to 130° C. at the rate of 10° C./min.

### Adhesion to PROTEIN LEATHER

Test substrate: PROTEIN LEATHER PBZ13001 KAKI (IDEATEX Japan Co. Ltd.), Protein Leather is made by specialized resins with Protein Powder. The Protein Leather PBZ has human skin-like superb tactility, many cosmetic companies are using it for cosmetic testing application.

Synthetic sweat dispersion: Synthetic sweat dispersion is used for wet stick testing, and it was prepared by mixing the following material.

### Synthetic Sweat Dispersion: 750 ml Synthetic Sweat+0.75 g Synthetic Sebum

| | | | |
|---|---|---|---|
| Synthetic sweat | Sodium chloride | 3.75 | g |
| | Urea | 0.75 | g |
| | Lactic Acid | 0.75 | g |
| | 10% Ammonium hydroxide | 1.5 | g |
| | solution | | |
| | Deionized Water | 750 | ml |
| Synthetic sebum | Olive oil | 5.5 | g |
| | Oleic acid | 2.5 | g |
| | Squalene | 2.0 | g |

### Dry Adhesin to Protein Leather

25 mm×125 mm size tape sample was laminated on 30 mm×125 mm size PL by using 2 kg roller. The applied tape was removed with T-peel with 150 mm/min test speed by using peel tester SP-2100 (Imass), and the average peel adhesion was recorded.

### Wet Adhesion to Protein Leather

Synthetic sweat dispersion was sprayed on to protein leather and allowed to dwell for 10~40 min. after wiping the protein leather, synthetic sweat dispersion was sprayed again (5 times). The T-peel adhesion was measured by same procedure as dry adhesion.

### Shrinkage Test

A square of adhesive on release liner measuring 10 cm by 10 cm was cut and folded on itself parallel to the coating direction of the solventless adhesive. Gentle pressure was applied, and the release liner was removed from the top. To the adhesive sample now measuring 10 cm by 5 cm, the adhesive was again folded parallel to the coating direction with gentle application of pressure, resulting in a 10 cm by 2.5 cm sample. The process of folding and applying pressure was repeated one additional time, resulting in a final sample dimension of 10 cm (length) by 1.25 cm (width) and defined as the unrelaxed length. This adhesive sample was then placed in a bed of talc and the adhesive in talc was warmed to 65° C. for 3 minutes. The length of the sample was then measured to give the “relaxed” sample length. The shrinkage of the sample was defined as (“unrelaxed length”−“relaxed length”)/“relaxed length.

### Wet Shear Adhesion on Protein Leather

DCT (double coated tape-tape laminated to Sontara backing) or ATT (adhesive transfer tape-tape laminated to two release liners) samples were cut to 25 mm×25 mm size. After liner removal, 1^{st} adhesive surface was laminated to a polycarbonate sheet (30 mm×30 mm×2 mmt). Filament tape was laminated on another surface of the polycarbonate sheet as pull tub. Synthetic sweat dispersion was sprayed on to protein leather and allowed to dwell for 10~40 min. after wiping the protein leather, synthetic sweat dispersion was sprayed again (5 times). Test sample was put on the wet test substrate after the 2^{nd} liner removal, then 275 g weight was put on it for 1 min. Filament tub was pulled to horizontal direction with 90 inch/min test speed, and peak adhesion was measured in Newtons.

### EXAMPLES

### Examples 1 (E-1A-E-1H)

Samples of material from Examples E-1A-E-1H in Table 1 (Raw Materials RM are in parts by weight) was compounded in a twin screw extruder at 300° F. (149° C.) and 300 rpm for three minutes. The resulting hotmelt was coated onto a silicone release liner using a drop die. The extrusion temperatures for the die and extruder were kept at 300° F. (149° C.). The extruded samples were coated at 1.5 mil (38 micrometers) thickness. In a separate step, the samples were then cured at 40 mJ/cm² of UV-C radiation using a UV fusion lamp and H-bulb. The samples were later hand laminated onto Polyurethane to create the final construction. The gel contents were tested and summarized below.

TABLE 1
Adhesive composition and gel content data

| RM | Ex-1A | Ex-1B | Ex-1C | Ex-1D | Ex-1E | Ex-1F | Ex-1G | Ex-1H |
|---|---|---|---|---|---|---|---|---|
| GA-1 in 2EHA (49%) | 20 | 20 | 20 | 20 | 20 | 20 | 20 | 20 |
| 2EHA | 65 | 65 | 65 | 65 | 65 | 65 | 65 | 65 |
| AA | 15 | 15 | 15 | 15 | 15 | 15 | 15 | 15 |
| PI | 0.15 | 0.15 | 0.15 | 0.15 | 0.15 | 0.15 | 0.15 | 0.15 |
| IOTG | 0.33 | 0.21 | 0.285 | 0.21 | 0.265 | 0.35 | 0.275 | 0.33 |
| KAEBP in 2EHA (50/50) | 0.146 | 0.164 | 0.1322 | 0.08 | 0.2 | 0.08 | 0.08 | 0.2 |
| AO-1 | 0.4 | 0.4 | 0.4 | 0.4 | 0.4 | 0.4 | 0.4 | 0.4 |
| IV | 0.42 | 0.6 | 0.4983 | 0.6 | 0.546 | 0.42 | 0.519 | 0.42 |
| Gel content % 40 mJ/cm² | 67.8 | 80.8 | 74.6 | 77.1 | 80.2 | 11.8 | 61.4 | 78.1 |
| Gel content % 40 mJ/cm² + | 64.8 | 80.4 | 69.3 | 74.7 | 76.7 | 34.8 | 64.6 | 73.3 |
| gamma irradiation | | | | | | | | |

### Examples 2 (E-2A-E-2D) and Comparative Example CE2

The solventless acrylate adhesives E-2A-E-2D and Comparative Example CE2 shown in Table 2 (Raw Materials RM are in parts by weight) were pattern coated onto two-side silicone coated liner (Loparex, Hammond, WI) with coat weight 6 grains/24 inch² (6 grains/155 cm²) and then UV cured at dose 50 mJ/cm² (Hammer UV unit, H-Bulb). The adhesive was laminated with polyurethane film (Lubrizol, Wickliffe, OH) and then gamma irradiated at approximately 30 kGy. The gel content, adhesion to steel and shear performance testing were summarized in below Table 2.

TABLE 2
Solventless adhesive composition and performance.

| RM | E-2A | E-2B | E-2C | E-2D | CE2 |
|---|---|---|---|---|---|
| GA-1 in | 20 pure | 20 pure | 20 pure | NA | NA |
| 2EHA (~49 | | | | | |
| wt %) | | | | | |
| GA-2 | NA | NA | NA | 20 | NA |
| 2EHA | 65 | 65 | 65 | 65 | NA |
| DDA | NA | NA | NA | NA | 98 |
| AA | 15 | 15 | 15 | 15 | 2 |
| PI | 0.15 | 0.15 | 0.15 | 0.15 | 0.2 |
| IOTG | 0.20 | 0.15 | 0.20 | 0.20 | 0.06 |
| KAEBP in | 0.08 (pure) | 0.08 (pure) | 0.15 (pure) | 0.08 (pure) | NA |
| 2EHA (50/50) | | | | | |
| ABP | NA | NA | NA | NA | 0.05 |
| AO-1 | 0.4 | 0.4 | 0.4 | 0.4 | 0.4 |
| HDDA | NA | NA | NA | NA | 0.045 |
| Inherent | 0.643 | 0.621 | 0.858 | 0.677 | NA |
| viscosity in | | | | | |
| THF | | | | | |
| Gel content % | 69.03 | 63.19 | 74.26 | 68.02 | NA |
| Adhesion to | 15.2 (16.6) | NA | 11.9 (13.0) | 16.6 (18.2) | 4.8 (5.3) |
| steel in oz/inch | | | | | |
| (N/dm) | | | | | |
| Shear (days) | 1.9 | NA | 0.5 | 0.9 | 0.1 |

### Examples 3 (E-3A-E-3C) and Comparative Example CE3

The solventless acrylate adhesives E-3A-E-3C and CE3 shown in Table 3 (Raw Materials RMV are in parts by weight) were pattern coated onto two-side silicone coated liner (Loparex, Hammond, WI) with coat weight 5.5 grains/24 inch² (5.5 grains/155 cm²) and then UV cured at dose 40 mJ/cm² (Hammer UV unit, H-Bulb). The adhesive was laminated with polyurethane film (Lubrizol, Wickliffe, OH) and then gamma irradiated at approximately 30 kGy. The adhesion to steel was measured and are summarized in below Table 3.

TABLE 3
Solventless adhesive composition and performance

| RM | E-3A | E-3B | E-3C | CE3 |
|---|---|---|---|---|
| GA-2 | 20 | 20 | 20 | NA |
| 2EHA | 65 | 65 | 65 | 85 |
| BA | NA | NA | NA | 10 |
| AA | 15 | 15 | 15 | 5 |
| PI | 0.15 | 0.15 | 0.15 | NA |
| IOTG | 0.20 | 0.20 | 0.25 | |
| AEBP | NA | NA | NA | 0.125 |
| KAEBP in | 0.1 | 0.05 | 0.05 | NA |
| 2EHA | (pure) | | | |
| (50/50) | | | | |
| OA-1 | 0.4 | 0.4 | 0.4 | NA |
| OA-2 | NA | NA | NA | 0.5 |
| Adhesion | 18.0 | 23.2 | 23.2 | 10.5 |
| to steel | (19.7) | (25.4) | (25.4) | (11.5) |
| oz/inch | | | | |
| (N/dm) | | | | |

### Examples 4 (E-4A-E-4I)

The solventless acrylate adhesives E-4A-E-4I shown in Table 4 (Raw Materials RM are in parts by weight) were pattern coated onto two-side silicone coated liner (Loparex, Hammond, WI) with coat weight 5.5 grains/24 inch² (5.5 grains/155 cm²) and then UV cured at dose 50 mJ/cm² (Hammer UV unit, H-Bulb). The adhesive was laminated with polyurethane film (Lubrizol, Wickliffe, OH) and then gamma irradiated at approximately 30 kGy. The adhesion to steel, moisture vapor transmission rate data are summarized in below Table 4.

TABLE 4
Solventless adhesive composition and performance

| RM | E-4A | E-4B | E-4C | E-4D | E-4E | E-4F | E-4G | E-4H | E-4I |
|---|---|---|---|---|---|---|---|---|---|
| GA-1 in 2EHA (49%) | 20 (pure) | 20 | 10 | 14.25 | 10 | 16.9 | 20 | NA | 20 |
| GA-2 | NA | NA | NA | NA | NA | NA | NA | 20 | NA |
| 2EHA | 67.4 | 73 | 75 | 75.27 | 78.56 | 68.1 | 20 | 65 | 65 |
| DDA | NA | NA | NA | NA | NA | NA | 45 | NA | NA |
| AA | 12.6 | 7 | 15 | 10.48 | 11.44 | 15 | 15 | 15 | 15 |
| PI | 0.15 | 0.15 | 0.15 | 0.15 | 0.15 | 0.15 | 0.15 | 0.15 | 0.15 |
| IOTG | 0.175 | 0.16 | 0.19 | 0.17 | 0.165 | 0.17 | 0.20 | 0.20 | 0.20 |
| KAEBP in 2EHA (50/50) | 0.08 pure | 0.08 | 0.08 | 0.08 | 0.08 | 0.08 | 0.08 | 0.08 | 0.08 |
| OA-1 | 0.4 | 0.4 | 0.4 | 0.4 | 0.4 | 0.4 | 0.4 | 0.4 | 0.4 |
| Gel content % | 68.4 | 68.9 | 65.8 | 53.9 | 67.8 | 66.8 | 64.3 | 64.5 | 72.9 |
| G′ at 32° C. × 10⁶ Pa | 0.0273 | 0.0150 | 0.0522 | 0.11038 | 0.0808 | 0.0896 | 0.0889 | 0.0714 | 0.0774 |
| Adhesion to steel oz/ | 11.0 | 9.8 | 11.3 | 12.9 | 11.8 | 12.6 | 13.7 | 12.2 | 10.8 |
| inch (N/dm) | (12.0) | (10.7) | (12.4) | (14.1) | (12.9) | (13.8) | (15.0) | (13.3) | (11.8) |
| MVTR upright g/m² 24 hr | 1281 | 1318 | 1141 | 1359 | 1094 | 1064 | 1065 | 1105 | 1386 |
| MVTR inverted g/m² 24 hr | 3418 | 4015 | 4470 | 4623 | 4231 | 3623 | 3861 | 4651 | 5288 |
| Shear/days | 2.4 | 0.9 | 1.2 | 2.4 | 0.02 | 16.3 | 3.0 | 2.8 | 5.4 |
| 2EHA residue PPM | 683 | 504 | 570 | 480 | 496 | 348 | 277 | 243 | 230 |
| DDA residue PPM | NA | NA | NA | NA | 21.8 | 175 | 735 | 206 | 45 |
| AA residue PPM | 3.29 | 2.86 | 1.88 | 2.30 | 1.58 | 3.03 | 2.48 | 1.93 | 1.97 |

### Examples 5 (E-5A-E-5C and CE5A, CS5B)

The solventless acrylate adhesives E-5A-E-5C and CE5A shown in Table 5 (Raw Materials RM are in parts by weight) were pattern coated onto two-side silicone coated liner (Loparex, Hammond, WI) with coat weight 5.5 grains/24 inch² (5.5 grains/155 cm²) and then UV cured at dose 50 mJ/cm² (Hammer UV unit, H-Bulb). CE5B adhesive was continuous coated with no UV. The adhesive was laminated with polyurethane film (Lubrizol, Wickliffe, OH) and then gamma irradiated at approximately 30 kGy.

TABLE 5
The solventless adhesive composition

| RM | E-5A | E-5B | E-5C | CE5A | CE5B |
|---|---|---|---|---|---|
| GA-1 in | 10 pure | 15.5 | 20 | NA | NA |
| 2EHA (49%) | | | | | |
| 2EHA | 83 | 77.5 | 65 | 85 | 65 |
| BA | NA | NA | NA | 10 | NA |
| AA | 7 | 7 | 15 | 5 | 15 |
| EO/PO BC | NA | NA | NA | NA | 20 |
| PI | 0.15 | 0.15 | 0.15 | NA | NA |
| IOTG | 0.140 | 0.150 | 0.25 | | 0.03 |
| HDDA | NA | NA | NA | NA | 0.003 |
| KAEBP in | 0.08 | 0.08 | 0.15 | NA | NA |
| 2EHA | | | | | |
| (50/50) | | | | | |
| AEBP | NA | NA | NA | 0.125 | NA |
| OA-1 | 0.4 | 0.4 | 0.5 | NA | NA |
| OA-2 | NA | NA | NA | 0.5 | 0.5 |

The samples were evaluated in a clinical study, described below. A controlled, randomized, single-blinded in-house clinical study was conducted. Three sets of samples were first cut into 3 inch (7.6 cm) strips, and then were applied to the intact skin of healthy volunteer's back which have been prepared with 2% CHG (chlorohexidine gluconate) swabs (1.8-2.2% CHG, 63-77% alcohol). The first set of samples were removed using IMASS SP-2100 to obtain T0/Pre-Exercise skin adhesion data within 5-15 minutes of dwell time after initial application. The subject was then asked to exercise either run or walk on a treadmill to generate sweat to simulate wet condition, when the subject reached the target heartbeat, they kept the heartbeat for 30 minutes, then T0/post Exercise samples were removed using IMASS SP-2100 to obtain skin adhesion data. 24 hours later, T24/post exercise samples were removed to obtain skin adhesion data. Edge lift on a 0-100% scale was also observed and recorded prior to T24/post exercise samples' removal. The results are summarized in Table 6 below.

TABLE 6
Skin adhesion and edge lift data

| | | T0 post | T 24 hr post | |
|---|---|---|---|---|
| | T0 pre exercise | exercise skin | exercise skin | T 24 hr post |
| | adhesion | adhesion | adhesion | exercise lift |
| Formulation | Gram/inch | Gram/inch | Gram/inch | % |
| E-5A | 203.4 ± 53.7 | 104.7 ± 69.4 | 436.27 ± 89.4 | 0.19 ± 0.75 |
| E-5B | 231.2 ± 62.9 | 129.6 ± 102.2 | 449.5 ± 148.5 | 0.19 ± 0.75 |
| E-5C | 101.7 ± 34.3 | 86.2 ± 59.6 | 226.1 ± 63.1 | 0.94 ± 2.57 |
| CE5A | 132.3 ± 34.9 | 73.0 ± 40.1 | 257.9 ± 108.1 | 1.06 ± 2.67 |
| CE5B | 128.2 ± 40.5 | 136.3 ± 89.4 | 231.9 ± 84.4 | 1.19 ± 4.75 |

EM-05-014900 n = 16.

### Examples 6 (E-6A-E-6D)

The solventless acrylate adhesives E-6A-E-6D shown in Table 7 (Raw Materials RM are in parts by weight) were coated onto two-side silicone coated liner (Fujimori Kogyo, Filmbyna TSB/TSC) with coat weight 23.5 grains/24 inch² (23.5 grains/155 cm²) and then UV cured at dose 60 mJ/cm² (Heraeus UV unit, H-Bulb). The adhesive was laminated with Sontara and then tested for adhesion to protein leather. For Example E-6D, the sample prior to lamination to Sontara (called ATT for Adhesive Transfer Tape) and the sample laminated to Sontara (called DCT for Double Coated Tape) were tested for Wet Shear on PROTEIN LEATHER according to the test method above. The data are presented in Table 7.

TABLE 7
Adhesive composition and adhesion to protein leather

| | E-6A | E-6B | E-6C | E-6D |
|---|---|---|---|---|
| DDA | 65 | 74 | 97 | 97.5 |
| NVP | NA | 5 | NA | 2 |
| GA-2 | 20 | 20 | NA | NA |
| AA | 15 | 1.0 | 3.0 | 0.5 |
| HDDA | NA | NA | 0.0335 | 0.01 |
| IOTG | 0.20 | 0.10 | 0.10 | 0.10 |
| KAEBP 50% | 0.20 | 0.20 | 0.02 | NA |
| in IOA | | | | |
| ABP 25% | NA | NA | NA | 0.40 |
| PI | 0.20 | 0.30 | 0.20 | 0.30 |
| PI-2 | 0.30 | 0.20 | 0.30 | 0.20 |
| Shrinkage % | 5% | −2% | 27% | 18% |
| dry | 6.48 (7.10) | 8.1 (8.88) | 6.6 (7.20) | 4.75 (5.21) |
| oz/25 mm | | | | |
| (N/dm) | | | | |
| wet | 4.0 (4.40) | 3.6 (3.95) | 4.0 (4.40 | 2.70 (2.96) |
| oz/25 mm | | | | |
| (N/dm) | | | | |
| Wet Shear | — | — | — | 5.23 |
| ATT (N) | | | | |
| Wet Shear | — | — | — | 5.28 |
| DCT (N) | | | | |

### Examples 7 (E-7A-E-7F)

The solventless acrylate adhesives E-7A-E-7E in Table 8 (Raw Materials RM are in parts by weight) were either continuous coated or pattern coated onto two-side silicone coated liner (Loparex, Hammond, WI) with coat weight 6-12 grains/24 inch² (6-12 grains/155 cm²) and then UV cured at dose 50-60 mJ/cm² (Hammer UV unit, H-Bulb). Two layers of adhesives were laminated together and them laminated onto either Sontara (Glatfelter, Charlotte, NC) or polyurethane film (BASF, Ludwigshafen, Germany) and then gamma irradiated at approximately 30 kGy and tested for adhesion to protein leather (Table 9).

TABLE 8
The solventless adhesive composition

| RM | E-7A | E-7B | E-7C | E-7D | E-7E | E-7F |
|---|---|---|---|---|---|---|
| GA-1 in 2EHA (49%) | 10 pure | 10 pure | 10 pure | NA | NA | 15.5 pure |
| GA-2 | NA | NA | NA | 20 | 20 | NA |
| 2EHA | 68.56 | 68.56 | 68.56 | 65 | 65 | 62 |
| AA | 11.44 | 11.44 | 11.44 | 15 | 15 | 7 |
| PI | 0.15 | 0.15 | 0.15 | 0.15 | 0.15 | 0.15 |
| IOTG | 0.165 | 0.165 | 0.165 | 0.20 | 0.20 | 0.15 |
| KAEBP in 2EHA (50/50) | 0.08 | 0.08 | 0.08 | 0.08 | 0.08 | 0.08 |
| OA-1 | 0.4 | 0.4 | 0.4 | 0.4 | 0.4 | 0.4 |
| Coating | Continuous | Pattern | Pattern | Continuous | Pattern | Pattern |
| UV dose mJ/cm² | 50 | 60 | 50 | 50 | 50 | 100 |
| Coat weight (grains/ | 6 | 11 | 6 | 6 | 6 | 10 |
| 24 inch²) or (grains/ | | | | | | |
| 155 cm²) | | | | | | |

TABLE 9
sample construction and adhesion to protein leather

| | Sontara/E-7A/E- | | Sontara/E-7D/E- | | Sontara/E-7C/E- | | Polyurethane/E- | |
|---|---|---|---|---|---|---|---|---|
| | 7E | | 7B | | 7F | | 7E/E-7C | |
| Dry | 9.2 | (10.08) | 8.5 | (9.32) | 10.5 | (11.51) | 9.9 | (10.85) |
| oz/inch | | | | | | | | |
| (N/dm) | | | | | | | | |
| Wet | 10.0 | (10.96) | 7.9 | (8.66) | 9.9 | (10.85) | 10.2 | (11.18) |

oz/inch
(N/dm)

What is claimed is:

1. An article comprising:
a substrate; and
a layer disposed on at least a portion of the substrate, the layer comprising at least one hot melt processable pressure sensitive adhesive that has been coated and photocrosslinked, the at least one hot melt processable pressure sensitive adhesive comprising a (meth)acrylate-based copolymer that is the reaction product of a reaction mixture comprising:
at least one first (meth)acrylate monomer of general formula I: 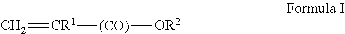
wherein R¹ is hydrogen or a methyl group; and
R² is an alkyl, alkenyl, or aryl group comprising 4-20 carbon atoms; and
at least one second (meth)acrylate monomer of general Formula II: 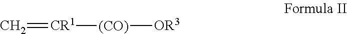
wherein R¹ is hydrogen or a methyl group; and
R³ is an alkylene oxide group that is capped with an alkyl group;
at least one co-polymerizable reinforcing monomer;
at least one co-polymerizable photocrosslinker; and
at least one initiator.

2. The article of claim 1, wherein the substrate comprises a polymeric film, a fabric, a non-woven, a foam, a paper, a mesh, an adhesive, or a release liner.

3. The article of claim 1, wherein the at least one first (meth)acrylate monomer of general Formula I: 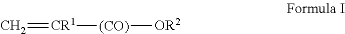
wherein R¹ is hydrogen or a methyl group; and
R² is an alkyl, group comprising 4-12 carbon atoms.

4. The article of claim 1, wherein the at least one second (meth)acrylate monomer is of general Formula II: 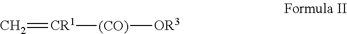
wherein R¹ is hydrogen or a methyl group; and
R³ is a polyethylene oxide group capped with an alkyl group.

5. The article of claim 1, wherein the at least one second (meth)acrylate monomer is of general Formula II: 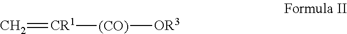
wherein R¹ is hydrogen or a methyl group; and
R³ is of general Formula III: 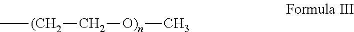
wherein n is an integer of 8-230.

6. The article of claim 1, wherein the at least one co-polymerizable reinforcing monomer comprises an acid-functional monomer.

7. The article of claim 1, wherein the reaction mixture comprises:
50-85 parts by weight of at least one first monomer;
5-30 parts by weight of at least one second monomer;
3-25 parts by weight of at least one co-polymerizable reinforcing monomer;
0.05-0.5 parts by weight of at least one co-polymerizable photocrosslinker; and
0.01-1.0 parts by weight of at least one initiator.

8. The article of claim 1, wherein the layer comprising at least one hot melt processable pressure sensitive adhesive comprises a continuous layer, a patterned layer, or a combination thereof.

9. The article of claim 1, wherein the layer comprising at least one hot melt processable pressure sensitive adhesive comprises a layer of a first hot melt processable pressure sensitive adhesive composition comprising a continuous layer, and a second hot melt processable pressure sensitive adhesive composition comprising a patterned layer.

10. The article of claim 1, wherein the article comprises a polyurethane film substrate and has a 24 hour inverted Moisture Vapor Transmission (MVT) rate of 350-20,000 g/m².

11. The article of claim 1, wherein the article has a peel adhesion to dry PROTEIN LEATHER of 40-400 grams/inch.

12. The article of claim 1, wherein the article has a peel adhesion to wet PROTEIN LEATHER of 30-300 grams/inch.

13. The article of claim 1, wherein the layer comprising a hot melt processable pressure sensitive adhesive further comprises at least additive selected from an anti-oxidant, tackifier, and a plasticizer.

14. An adhesive composition comprising:
a hot melt processable (meth)acrylate-based copolymer that is the reaction product of
a reaction mixture comprising:
at least one first (meth)acrylate monomer of general formula I: 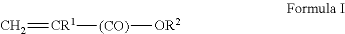
wherein R¹ is hydrogen or a methyl group; and
R² is an alkyl, alkenyl, or aryl group comprising 4-20 carbon atoms; and
at least one second (meth)acrylate monomer of general Formula II: 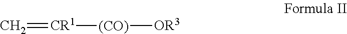
wherein R¹ is hydrogen or a methyl group; and
R³ is an alkylene oxide group that is capped with an alkyl group;
at least one co-polymerizable reinforcing monomer; and
at least one co-polymerizable photocrosslinker; and
at least one initiator.

15. The adhesive composition of claim 14, wherein the reaction mixture further comprises a chain transfer agent.

16. The adhesive composition of claim 14, wherein the at least one first (meth)acrylate monomer of general Formula I: 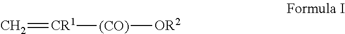
wherein R¹ is hydrogen or a methyl group; and
R² is an alkyl, group comprising 4-12 carbon atoms.

17. The adhesive composition of claim 14, wherein the at least one second (meth)acrylate monomer is of general Formula II: 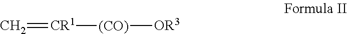
wherein R¹ is hydrogen or a methyl group; and
R³ is a polyethylene oxide group capped with an alkyl group.

18. The adhesive composition of claim 14, wherein the at least one second (meth)acrylate monomer is of general Formula II: 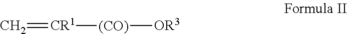
wherein R¹ is hydrogen or a methyl group; and
R³ is of general Formula III: 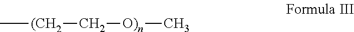
wherein n is an integer of 8-230.

19. The adhesive composition of claim 14, wherein the reaction mixture comprises:
50-85 parts by weight of at least one first monomer;
5-30 parts by weight of at least one second monomer;
3-25 parts by weight of at least one co-polymerizable reinforcing monomer;
0.05-0.5 parts by weight of at least one co-polymerizable photocrosslinker; and
0.01-1.0 parts by weight of at least one initiator.

20. The adhesive composition of claim 14, wherein the hot melt processable (meth)acrylate-based copolymer is photocrosslinkable.
